(19) United States
(12) Patent Application Publication
(10) Pub. No.: US 2002/0090082 A1
(43) Pub. Date: Jul. 11, 2002

(54) Low radiation cellular phone

(76) Inventor: Kevin A. McLean, Tampa, FL (US)

Correspondence Address: FROMMER LAWRENCE & HAUG LLP, 745 FIFTH AVENUE, NEW YORK, NY, 10151, US

(21) Appl. No.: 09/757,335

(22) Filed: Jan. 9, 2001

(51) Int. Cl. H04M 1/00; H04M 9/00

(52) U.S. Cl. 379/433.08

(57) ABSTRACT

The low radiation cellular phone dramatically lowers the amount of radiation absorbed by the brain by moving the lowest source of radiation closer to the brain, thereby moving those components that emit greater amounts of radiation further from the brain. The battery, which is the lowest source of radiation, is located at the top of the cellular phone, thereby moving the circuit boards which emit greater amounts of radiation further from the brain.

### BACKGROUND OF INVENTION

The field of endeavor to which this invention pertain to is the level of radiation emitted to the brain by cellular phones.

Current cellular phones emit radiation in very small amounts. However, because the source of radiation emissions is very close to the brain, concerns have been raised that the radiation may be causing brain cancer. In fact, the U.S. Federal Communications Commission recently set certain standards for cellular phone radiation absorption. Specifically, the FCC set the standard of 1.6 W/kg for partial-body exposure measured over 1 gram of tissue. This is referred to as the specific absorption rate (SAR) of the phone's radio frequency energy by the brain tissue. The SAR is a way of measuring the quantity of radio frequency (RF) energy that is absorbed by the body.

The amount of radiation plunges dramatically within inches of the cellular phone and its antenna. Yet, current cellular phones are configured so that that components that emits the most radiation is closest to the brain and the component that emits the least radiation is furthest from the brain. Specifically, the antenna emits the greatest amount of radiation and is the closest Component to the brain. The battery emits the least amount of radiation and is the furthest from the brain.

### BRIEF SUMMARY OF THE INVENTION

This invention solves the problems described in the Background of Invention. The invention is a low radiation cellular phone in which the component that emits the least amount of radiation is the closest to the brain, thereby relocation those components that emit greater radiation further from the brain. Specifically, the battery, which is typically located at the bottom of the cellular phone, is located at the top of the cellular phone. This places those components (circuit boards) that emit the much greater amounts of radiation at the further point from the brain.

### BRIEF DESCRIPTION OF THE DRAWINGS

FIG. 1 is an illustration of the low radiation cellular phone that has the battery at the top.

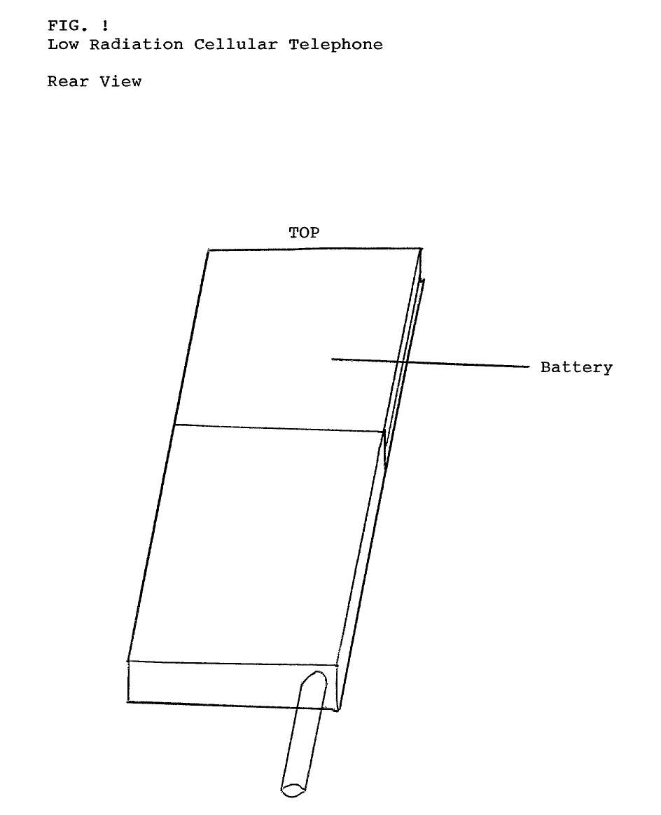

### DETAILED DESCRIPTION OF THE INVENTION

The low radiation cellular phone places the lowest source of radiation the closest to the brain. The battery, which emits the least amount of radiation, is moved from the bottom to the top. Thus, greater sources of radiation (circuit boards) are moved from the further from the brain.

Moving the antenna from the closest point to the brain to the furthest point from the brain will dramatically decrease the specific absorption rate (SAR) of the cellular phone, thereby decreasing the risk of cancer and reducing the user's fear of using the cellular phone. By moving circuit boards moved from two inches from the brain to four inches from the brain, the amount of radiation to which the brain is exposed will drop approximately seventy-five percent.

What is claimed is:

1. A cellular phone apparatus that has its source of lowest radiation closest to the brain comprising:
a cellular phone having the battery on the top.
